(19) United States
(12) Patent Application Publication
(10) Pub. No.: US 2004/0022961 A1
(43) Pub. Date: Feb. 5, 2004

(54) Screen element for a high resolution screen

(76) Inventor: Hartmut Dietz, Pfalzgrafenweiler (DE)

Correspondence Address: BACHMAN & LAPOINTE, P.C., 900 CHAPEL STREET, SUITE 1201, NEW HAVEN, CT, 06510, US

(21) Appl. No.: 10/312,456

(22) PCT Filed: Jun. 19, 2001
(86) PCT No.: PCT/DE01/02238

(51) Int. Cl. C09K 19/00

(52) U.S. Cl. 428/1.1

(57) ABSTRACT

The present invention relates in particular to high resolution large displays, the basic idea being to compose the display of many transparent films. This is done by firstly composing individual screen elements of said films and then stacking the elements to form a large display. The construction makes it possible to lead the conductor tracks away toward the rear and thus also to shift the terminal points toward the rear. The lateral edge at the respective screen element is thus obviated and the individual screen elements can be strung together to form a large display in a manner that is not visible to the observer. Depending on the construction and formation of the films, the pixels are generated by means of liquid crystals or organic light-emitting polymers.

### DESCRIPTION

The present invention relates to a screen element and to a screen area produced therefrom and to a method for producing a screen element for a high resolution screen.

For large display areas, it has not been possible hitherto to produce high resolution display. If a large display area is required then this can be achieved by means of projection, for example. When using displays whose typical resolution is 640×480 to 1024×786 pixels, a plurality of devices have to be arranged one beside the other and one above the other in order to increase the resolution. However, since all these devices have an edge, the resulting picture is split into a plurality of visible regions.

When using a CRT monitor with a resolution of 1600×1280 pixels, a maximum size of a 24 inch screen diagonal is possible. With the prior art in the case of liquid crystals, displays with a maximum resolution of 1280×1024 pixels or a maximum of approximately 20 inches can be produced economically. As is known, for example in TFT technology, the individual pixels are driven by means of a matrix comprising horizontal and vertical conductor tracks. Situated at the crossover points thereof is a transistor which activates said pixel as soon as a current flows on both lines. If such a transistor is defective, said pixel can no longer be driven and remains permanently dark. Approximately 4 million transistors are required in the case of a large display having 1280×1024 pixels, since each pixel requires three colors. Ultraclean production rooms are required for production since a grain of dust immediately destroys a plurality of transistors. Consequently, the number of rejected displays is higher the larger the area becomes. In this case, too, a plurality of displays cannot simply be connected together since the terminal points and the mount of the front panel are accommodated on the side in the case of each display. As a result, an edge is likewise produced when a plurality of devices are arranged next to one another.

Therefore, the present invention is based on the object of proposing possibilities which enable high resolution large displays to be produced with uninterrupted display area.

This object is achieved according to the invention by means of a screen element having the features of the main claim. Further advantageous refinements can be gathered from the subclaims.

The basic idea of the invention is to compose the display of many films, thereby enabling conductor tracks to be led away toward the rear and thus the terminal points of the display also to be shifted toward the rear. As a result, the lateral edge at the respective display is obviated and the displays can be strung together seamlessly. Depending on how the pixels are illuminated, the films may be transparent or nontransparent. Transparent films are to be employed when the pixels are illuminated from the background, while nontransparent films can be used when the pixels are of self-luminous design.

According to the invention, a screen element comprises a stack of a plurality of plastic film blanks which can be shaped geometrically in a specific manner and be placed one on top of the other. Each plastic film blank has an end side forming the front visible display area, sides extending away toward the rear from the end side, and a rear side which connects the side. The sides extending away toward the rear may be at a right angle or else another suitable angle to the end side. Moreover, the rear side which connects the sides may be straight or have a radius, depending on the design. In the region of the end side, a metallization is situated on a first flat side of the plastic film blank and serves as ground potential for the respective film. Metallic terminals are situated on the opposite second flat side at least in the region of the end side, which terminals are spaced apart from one another and can be electrically driven separately, the size of the terminals corresponding to the size of the respective pixel. This can be done either by means of correspondingly designed pads or, given suitable technology, by means of a hole arranged in the film for receiving liquid crystal. Furthermore, there are situated on a plastic film blank electrical connecting lines from the end side terminals on the flat sides to the edges of the film sides extending away from the end side toward to the rear, and/or to the rear side. As a result, the terminals of the pixels are shifted toward the rear from the visible region. If the pixels are generated by means of liquid crystal, transparent films are used, as mentioned above. When the picture is produced by means of self-luminous material, it is possible, for example, to use an organic light-emitting polymer (OLEP). Since the latter is self-luminous, a nontransparent, preferably black plastic film is used.

In order to produce a screen element, a plurality of said films are placed one above the other and adhesively bonded, so that a stack already having a multiplicity of pixels is produced therefrom. Said stacks are lined up one next to the other and one above the other, so that an arbitrarily large display with a correspondingly required resolution can be assembled without the separation between the individual screen elements being visible to the observer, and the large display area appears as one area. An LCD area constructed in this way with transparent films then has, depending on the type of liquid crystal used, before the display area, corresponding additional elements such as, for example, spacers, color filters, pole filters, covering disc and the like in order to produce a suitable and compact screen of uniform appearance. Various possibilities known to the person skilled in the art are provided here. When using OLEP, the display area only requires a frame, a front protective disc and a rear housing. The technical outlay for polarization filters, spacers, etc., as is required for the LCD liquid crystal screen, is obviated here.

The object is additionally achieved by means of a method for producing a screen element in which an OLEP is used for the pixels. In accordance with the method, in order to produce a screen element, a stack of individual film blanks is treated jointly with regard to the end side, then separated again and each film is processed further on the first flat side (underside), and the picture element is subsequently produced by adhesively bonding the individual films.

In order to provide a better understanding of the invention and of the possible modifications, the invention is explained in more detail below using an exemplary embodiment. In the figures:

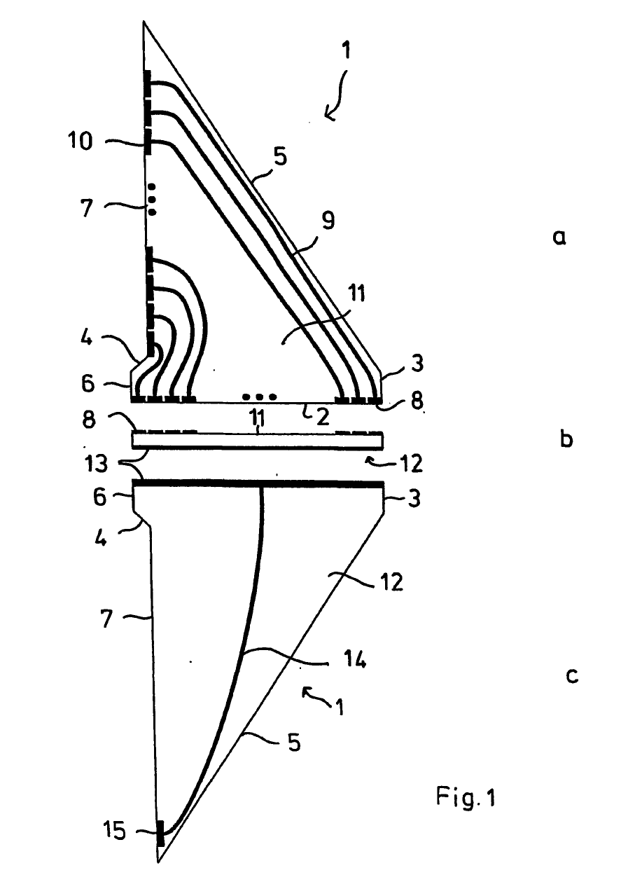

FIG. 1 illustrates a plastic film blank in plan view (a), in end view (b) and in the view from underneath (c);

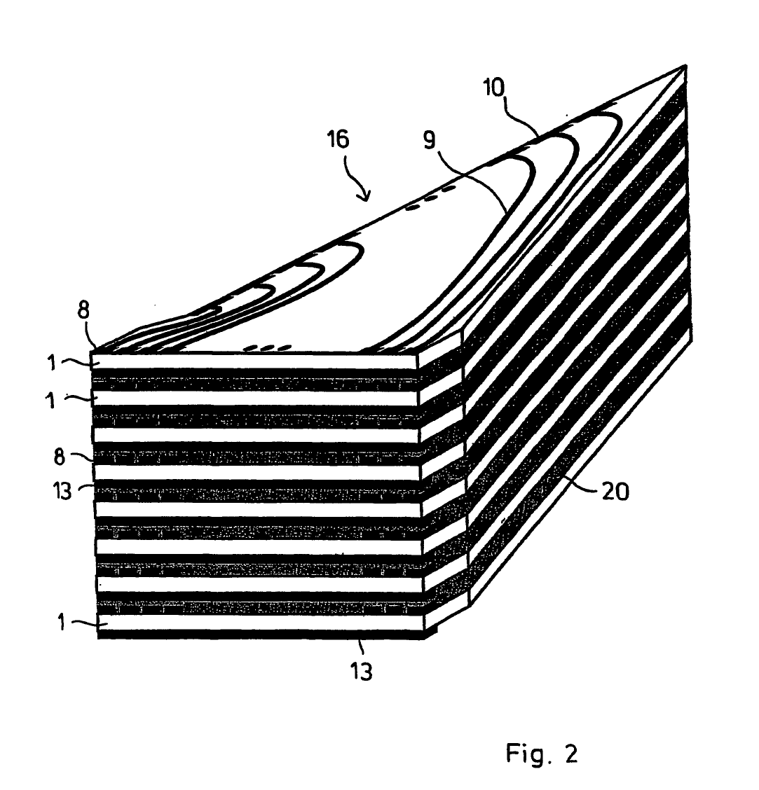

FIG. 2 illustrates the perspective view of a screen element comprising a stack of a plurality of plastic film blanks in accordance with FIG. 1;

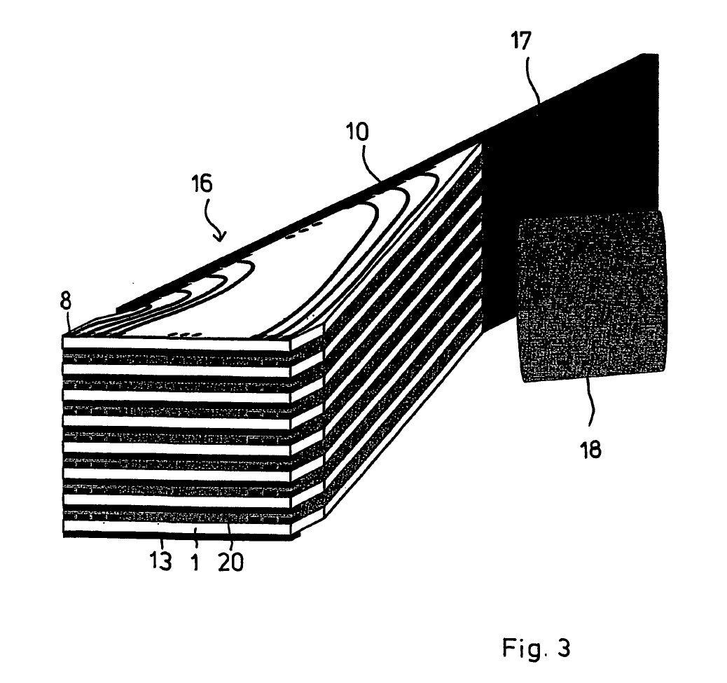

FIG. 3 illustrates a screen element in accordance with FIG. 2 with a terminal board;

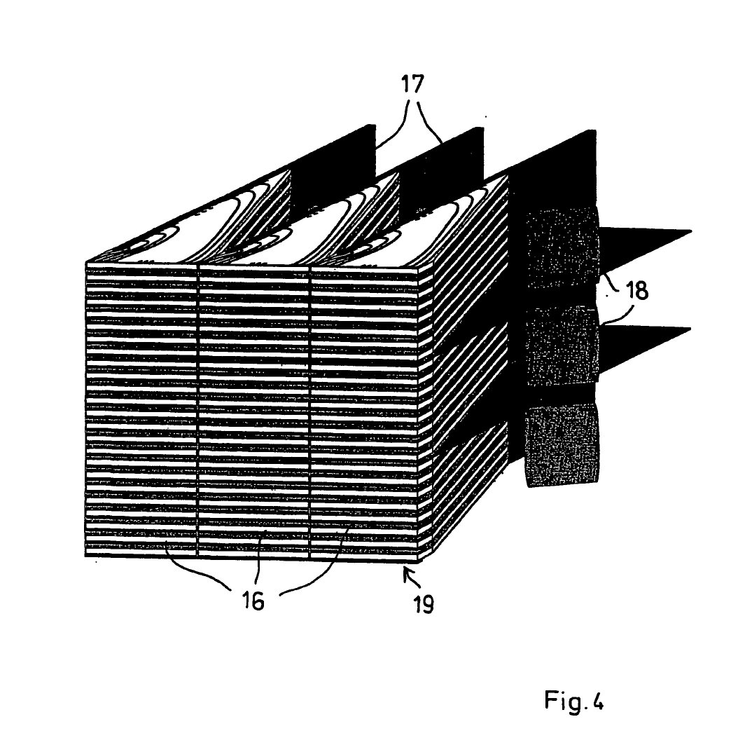

FIG. 4 illustrates an LCD area comprising a plurality of screen elements in accordance with FIG. 3; and

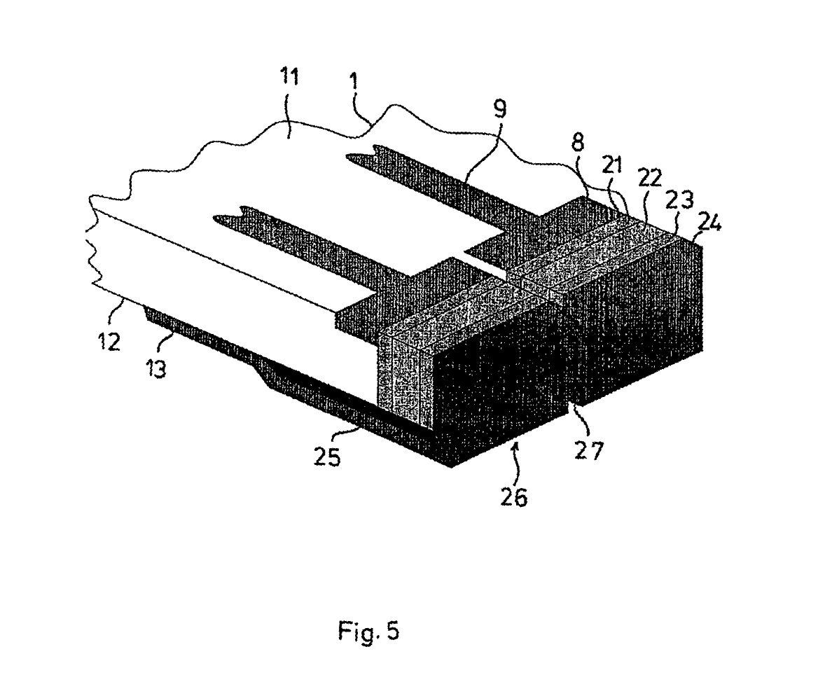

FIG. 5 illustrates an enlarged illustration of a detail from a film in the region of the end sides.

The plastic film blank 1 illustrated in FIG. 1 has, in plan view, an end side 2, sides 3, 4 which adjoin the latter and extend away at right angles toward the rear, and an inclined rear side 5 which connects the two sides 3 and 4. Depending on the optical requirements for the background illumination, the rear side 5 may have a radius in order to realize, together with the other films lying one on top of the other, a concave design at whose focal point the background illumination is then arranged. In the exemplary embodiment, the side 4 has a first region 6 and a set-back second region 7 adjoining the latter. The side 3 and the first region 6 are arranged at right angles to the end side in order later to serve, after the combination to form a stack, as a stop area for adjacent stacks. The second region 7 may also run obliquely with respect to the first region 6. The offset of the second region 7 with respect to the first region 6 results in a clearance for accommodating further terminal elements, as will be shown and explained later.

In the plan view in accordance with FIG. 1a, pads 8 are situated at the end side over the entire region, the respective width of which pads corresponds to the size of the respective pixels. Electrical connecting lines 9 lead from said pads to the end side terminals 10 at the edge of the plastic film blank 1 in the second region 7 of the side 4. The conductor tracks 9 on the plastic film blank 1 can be produced by various suitable methods. By way of example, it is possible to print a conductive material on the film by screen printing, firstly to mount or vapor-deposit a conductive material onto the film and subsequently to image the conductor tracks by means of an etching process, to emboss the conductor tracks with a conductive material, to burn in conductive material by means of a laser, or to introduce the conductor tracks by means of spark erosion. It is also possible to produce the conductor tracks by means of soft lithography.

In addition, if necessary, with regard to the respective conductor track 9, it is also possible to apply a memory element for each pixel on the film. For this purpose, a metal-insulator-metal element (MIM element), for example, may be used as memory element. In order to reduce the number of end side terminals 10 (pads) for connection to the control electronics, as an alternative, an intelligent chip may also be positioned on the film, which chip can drive all the pads 8 on the output side and manages with only a small number of supply, control and data lines on the input side. Said chip could, if, appropriate, also replace the above-mentioned memory cell (transistor+capacitor). If appropriate, the plastic film blank 1 may have an embossed depression for receiving the chip or a cutout may be provided in the overlying film.

For the functionality of the screen element, it is necessary at least to arrange liquid crystal in the known manner at the front side of the display area. As an alternative, however, it is also possible to incorporate the liquid crystal into the film, so that, instead of the pad 8, a hole is stamped into the film at a suitable location. Said hole is later filled with a liquid crystal and the liquid crystal is driven via the underlying and overlying film.

The plastic film blank 1 may also comprise composite longitudinal strips. This may become necessary depending on the type of liquid crystal if a polarizer has to be incorporated into the film. In this case, depending on the type of driving, it is also possible for either the film itself to be colored or a film strip with corresponding color to be incorporated. In this case, a transparent strip which can optically separate the individual pixels from one another may also be involved. In this case, the composition of the film can proceed to an extent such that a strip of the film already has the entire logic and driving for a pixel and these pixels then only have to be brought together.

In FIG. 1b, the end view shows the end side 2 of the plastic film blank 1 with the top side 11 and the underside 12. The top side 11 contains the pads 8, conductor tracks 9 and end side terminals 10 discussed in connection with FIG. 1a. A metallization 13 is situated on the underside 12 in the region of the end side 2, which metallization, as illustrated in FIG. 1c, leads via a conductor track 14 to a ground terminal 15 of the underside.

FIG. 2 shows a screen element 16 comprising a plurality of mutually stacked plastic film blanks 1 in accordance with FIG. 1. The individual plastic film blanks are adhesively bonded to one another by means of an adhesive 20.

FIG. 3 illustrates the screen element 16 together with a terminal board 17, which is inserted in the clearance produced by the offset of the second region 7 of the side 4 and contact-connects the individual plastic film blanks 1 at the end side terminals. The circuit carrier has the corresponding drive electronics for this LCD picture element. The background illumination 18 is indicated diagrammatically in FIG. 3.

An LCD picture area 19 which is formed from nine screen elements 16, each screen element in turn being composed of eight plastic film blanks. Each screen element 16 is assigned a background illumination 18. The LCD area 19 has no visible separations between the individual pixels. A mount (frame) with spacers and front panels, etc. additionally has to be provided before said picture area in order to create a correspondingly desired large display. This corresponds to the previously customary known technology.

In principle, in the case of the type of liquid crystal, there are various possibilities which also change the construction or the design of the plastic film blank and/or the driving of the respective screen element 16. It is thus possible, by way of example, to use organic LEDs. This material is self-luminous, so that there is no need for background illumination. Depending on the material, the latter already illuminates in the desired color or an additional color filter is necessary for the corresponding pixels. In this case, the design of the plastic film blank and the construction undertake only the pure driving of the LED.

The entire screen may be of either reflecting or transilluminating design. Accordingly, it may become necessary to adapt the plastic film blank in order to receive one or more polarizers. A liquid crystal may also be used for the so-called IPS mode (in-plane switching mode), in which the contacts of the switch lie in one plane.

As already indicated, one driving or another may be necessary or possible depending on the liquid crystal used. This extends from no background illumination in the case of reflection, through a monochrome background illumination in which three pixels are driven, to a color-changed background illumination. In the case of no and monochrome background illumination, the driving undertakes only the activation of the pixels, which can be done according to the previously known methods.

In the case of a color-changed background illumination, each pixel of a screen element is successively “switched to transparent” for a short time and for this purpose the background illumination is set with the desired color and intensity of said pixel. Thus, by way of example, the background illumination can be realized with red, green and blue LEDs in a correspondingly correct mixing ratio. The more pixels acquire their illumination from a background illumination, the faster each pixels must be able to be activated.

In the embodiment in accordance with FIG. 5, the plastic film blank no longer has to have a form we is illustrated in FIG. 1, since a background illumination is no longer required and, therefore, space is no longer found for the driving electronics at the side but rather directly on the rear side of the screen element, where either a circuit board or a chip can be connected to the element. The plastic film blank thus simply has only a rectangular form. In this embodiment, too, it is possible to apply transistors or a chip on the film surface, insofar as this is economically viable. Moreover, it is possible to construct or print on said transistors or an entire circuit made of polymer transistors (plastic transistors).

In accordance with the exemplary embodiment of FIG. 1, the plastic film blank 1 has pads 8 on the top side 11, which pads can be driven via connecting lines 9. Situated at the end side 2 of the plastic film are a first electrically conductive layer 21 and a second electrically conductive layer 23 between which an OLEP layer 22 is arranged. These two electrically conductive layers 21, 23 form the anode and the cathode for the OLEP layer 22. What serves as a ground terminal is a further electrically conductive layer 24 on the electrically conductive layer 23, which, in conjunction with the metallization 13 on the underside 12, serves as a common ground terminal, in the region of the end side 2, the metallization 13 being isolated from the layers 21, 22 and 23 by an insulation layer 25. The outer electrically conductive layer 24 makes it possible to provide a dedicated ground for each film. As a result, only relatively few pixels, for example 256, are associated with each ground, so that a passive matrix can be realized with this small number of pixels for each film. This is not possible in the case of the previously known constructions since the size of the passive matrix increases on account of the multiplex rate that rises with the size of the screen. If the multiplex rate is increased, that is to say the luminous duration is reduced within a specific picture buildup time, then the OLEP must be operated with a higher voltage. At some time the point is reached at which the high voltages either effects a crosstalk to the adjacent screen pixels or the OLEP is destroyed on account of excessively high pulse powers. In order to avoid this, an active matrix is used in which, as mentioned above, a transistor is situated at each crossover point, which transistor switches the actual power and thereby prevents a crosstalk on account of high voltages at a high multiplex rate. However, the destruction of the OLEP in the case of an excessively high pulse power cannot be eliminated as a result of this. This is prevented by the above-described construction with the electrically conductive layer 24. Furthermore, the order of the driving of the pixels can be varied much more simply in the case of a passive matrix with the construction described within a row than in the case of an active matrix in which the construction of the pixels is therefore usually effected successively row by row.

In the enlarged illustration in accordance with FIG. 5, the construction is only illustrated diagrammatically, without the relative sizes being taken into consideration. The thickness of the plastic film for the plastic blank 1 is approximately 100 μm and that of the connecting line 9 is approximately 30-40 μm. A pixel has a width of approximately 300 um and the cut 27 between two pixels 26 has a width of approximately 30 μm. By contrast, the layers 21-24 typically have a thickness of 20-100 nm and are thus smaller by a factor of 1000.

Since the OLEP is self-luminous in the case of an OLEP screen, the latter is not transilluminated from the rear. The layers 21-24 in the end side 2 are so thin that they are still transparent. In order to obtain a high contrast in this case, the plastic film is preferably chosen in a deep black in order that a nonluminous pixel acquires a deep black.

The three primary colors of the screen can be realized in different ways, in which case, irrespective of how the colors are realized, three films which are different in terms of the color effect are always adhesively bonded on one another and then together produce a series of pixels. Therefore, a film also has a thickness of only 100 μm and a pixel terminal 8 has a width of 300 μm in order to produce a square color pixel. In order to produce a color pixel, it is either possible to use each color (red, green blue) a specific type of OLEP for the respective pixel. Another possibility is to choose a specific OLEP color, for example white, and to apply a corresponding colored protecting layer (not illustrated) to the electrically conductive ground layer 24. The said protective layer is necessary anyway in order to prevent oxidation of the OLEP. Therefore, a color-modified plastic is then used instead of a clearly transparent liquid plastic. The thickness of this likewise transparent protective layer is in the μ range and, in an expedient manner, is also additionally applied over the entire screen area after the completion of the entire screen comprising different screen elements. The production of a screen element in accordance with FIG. 5 is effected in such a way that a plurality of plastic film blanks 1 provided with the pads 8 and electrical connecting lines 9 are placed together to form a block of loose plastic film layers that are not adhesively bonded to one another. In this case, the production of the electrical connecting lines 9 on the plastic film can be effected in such a way that the films are stamped to size and the connecting lines 9 are applied by means of screen printing. For further automation, the connecting lines 9 can be impressed in a pass onto the films by the soft lithography methods, the resulting capillaries can then be filled with conductive silver, and dried, and the films can be stamped out to size. Another possibility is to force liquid plastic into a mold, thereby producing the film blank with its capillaries. The capillaries are subsequently filled with conductive silver again and dried.

Once the films have been combined in a block, the end side 2 of the block is ground level and cleaned. In order to reduce the roughness of the end edge to a few nm, it is possible, if appropriate, to slightly melt the end side on a hot plate. If appropriate, the end face is cleaned or activated in a plasma in order to improve the adhesion of the subsequent layers.

Afterward, the electrically conductive layer 21 is produced on the end face of the block by means of sputtering, vapor deposition or spin-coating. The material varies depending on the OLEP used and may also be doped, if this is required by the OLEP. The layer thickness should be sufficiently conductive and still transparent and lie in the thickness range mentioned above. Afterward, the OLEP layer is applied to the end face of the block, for example by spin-coating, and dried. Other possibilities consist in inkjet printing or, if appropriate, also print-coating, spraying or dipping. The second electrically conductive layer 23 is then applied in a corresponding manner to the first electrically conductive layer 21. Until this point the films have still been tensioned as a block in an apparatus. They are now separated and isolated from one another and are processed further individually hereinafter.

In the case of each individual film, the layers 21-23 on the underside 12 of the film are insulated by an insulating layer 25 which is sputtered or applied by vapor deposition. The ground layer 24 (metallization 13) is then sputtered or vapor-deposited on the underside 12 and the end side 2. With a sawing cut perpendicular to the end side 2, the individual pixels, are produced and separated by the cut gap 27.

In order to avoid oxidation, the pixel layers produced are coated with a protective layer. The protective layer may likewise be either a sputtered layer or a layer applied by vapor deposition. Application by immersion in a liquid plastic is likewise possible.

Only now are the films adhesively bonded to form a screen element in accordance with FIG. 2. The individual screen elements are then assembled and adhesively bonded to one another to form the actual screen in the desired size. For completion, the latter still requires a frame, a front protective disk and a rear housing.

By means of the invention described above, it is thus possible to produce a high resolution large display without subdividing the picture area.

1. A screen element comprising a stack of a plurality of plastic film blanks (1) lying one on top of the other in a planar manner having
an end side (2) forming the front visible display area, sides (3, 6) extending away toward the rear from the end side, and a rear side (5) connecting the sides;
a metallization layer (13, 14) on a first flat side (12) at least in the region of the end side (2);
metallic pads (8) on the opposite second flat side (11) at least in the region of the end side (2), which pads are spaced apart from one another and can be electrically driven separately, the size of the pads (8) corresponding to the size of the respective pixel; and
electrical connecting lines (9, 14) from the pads (8) on the flat sides (11, 12) to the edges of the film sides (3, 6) extending from the end side toward the rear, and/or the rear side (5) and electrical contact connection of the pads (8) arranged on the individual plastic film blanks (1) to drive electronics on a film side (3, 6) set back relative to the side edge of the end side (2) and/or on the rear side (5),
the end sides (2) of the stacked plastic film blanks (1) determining the maximum height and width of the screen element including the associated driving electronics and, as a result, it being possible to arrange at each edge of the display area, one or more screen elements directly without a spacing that is visible during operation.

2. The screen element as claimed in claim 1, characterized in that the plastic film blanks (1) are produced from light-transmissive plastic.

3. The screen element as claimed in claim 1 or 2, characterized in that the sides (3, 4) are formed with different lengths.

4. The screen element as claimed in one of the preceding claims, characterized in that at least one side (4) has a first side region (6), which adjoins the end side, and a second side region (7), which is offset thereto in the direction of the other side (3) or runs obliquely with respect to the first side region.

5. The screen element as claimed in claim 4, characterized in that the external terminals (10) for the end side terminals (8, 13) are arranged at the second side region (7) and are connected to corresponding terminals on a circuit carrier (17), present at said side region, with driving electronics for this pixel.

6. The screen element as claimed in claim 1, characterized in that, in order to produce the individual pixels, the end side (2) of each plastic film has, corresponding to the width of the pads (8), two electrically conductive layers (21, 23) between which a light-emitting layer (22) is arranged, the inner layer (21) making electrical contact with the metallic pads (8) and the outer layer making electrical contact with the metallization layer (13).

7. The screen element as claimed in claim 6, characterized in that the light-emitting layer (22) is an organic light-emitting polymer.

8. The screen element as claimed in claim 6 or 7, characterized in that the respective metallization layer (24) is applied to the outer electrically conductive layer (23), which metallization layer is combined on the first flat side (12) as common ground of the individual pixels.

9. The screen element as claimed in claim 6 to 8, characterized in that the individual pixels (26) situated one above the other of three films (1) lying one above the other in each case form a color pixel, the individual pixels of a color pixel having the three primary colors, red, green, blue.

10. A screen area for a high-resolution screen, characterized in that it has a plurality of screen elements (16) as claimed in one of the preceding claims.

11. A method for producing a screen element as claimed in claim 8, characterized by the following steps:
combination of a plurality of plastic blanks (1) provided with the pads (8) and electrical connecting lines (9) to form a block of loose plastic film layers that are not adhesively bonded to one another, and leveling and cleaning of the end side (2) of the block,
application of a first electrically conductive layer (21) to the end face of the block, of a layer (22) made of an organic light-emitting polymer to the end face and of a second electrically conductive layer (23) to the end face, the layer thicknesses being chosen to be so thin that they are transparent in the visible optical wavelength range, separation of the films,
application of an electrically nonconductive layer (25) on the first flat side (12) in the region of the end side (2), application of an outer electrically conductive layer (24) as metallization for the ground terminal on the first flat side (12) at the end side (2),
separation of the layers applied on the end side (2) in accordance with the pads (8) by means of a cut perpendicular to the end side (2) in order to produce the individual pixels (26),
coating of the surfaces produced in the region of the end side with a transparent protective layer, and adhesive bonding of the films to form a screen element.
